(19) United States
(12) Patent Application Publication
(10) Pub. No.: US 2006/0277071 A1
(43) Pub. Date: Dec. 7, 2006

(54) Patient receiving method

(76) Inventor: John J. Shufeldt, Paradise Valley, AZ (US)

Correspondence Address: ETHERTON LAW GROUP, LLC, 5555 E. VAN BUREN STREET, SUITE 100, PHOENIX, AZ, 85008, US

(21) Appl. No.: 11/144,278

(22) Filed: Jun. 3, 2005

(51) Int. Cl. G06F 19/00

(52) U.S. Cl. 705/3

(57) ABSTRACT

An improved method of patient intake that enables a patient who arrives at a treatment facility to receive medical treatment on an expedited basis by providing for the administration of certain standing orders to further diagnose and treat the patient before he is seen by a doctor. The intake process is expedited by having the patient data entered by the patient, instead of by the providers; running certain intake processes in parallel instead of in series; and automating data exchange between multiple computer systems. The system accommodates patients with scheduled appointments as well as walk-ins.

### FIELD OF INVENTION

This invention relates to a method of more efficient patient intake. This invention particularly relates to a method of patient intake whereby a patient is recognized with the aid of an electronic database and administered a set of known standing orders before the patient sees a doctor or other health care provider.

### BACKGROUND

To receive medical care, a patient is received within a medical facility in a procedure known as “patient intake.” During patient intake, the patient typically has to arrive in advance of the scheduled appointment time to fill out a form with current contact and insurance information (even if it had not changed since the last visit), and fill out a medical history questionnaire, including current symptoms. This data is then manually entered into a database or the forms are simply added to the paper file. Even in emergency rooms, where a patient may be suffering a life-threatening problem, the patient must go through some level of patient intake that takes a significant amount of time.

Because current patient intake methods are so slow, patients can sometimes be forced to wait several hours before they actually receive any medical treatment. Long waits prevail at doctor's offices and emergency rooms alike. A part of the problem is that patients are typically taken in the order they arrive at the facility. If the registration for Patient A hits a snag, such as not being able to verify insurance quickly, the patients who arrived after Patient A must wait until the staff solves Patient A's problem. It would be desirable to have a system that can register and treat patients who arrive after Patient A and have no registration problems, without making them wait for others' problems to be solved.

Certain methods and devices are known that are designed to improve patient intake. For example, electronic records have been developed that enable a patient's medical history to be stored within an electronic database. These records are known as “electronic medical records” or “EMRs.” EMRs may be accessed by an identification card having data stored electronically thereon (or “smart card”) carried by the patient that can be provided to a medical provider in an emergency, giving the provider easy access to the patient's records. Smart cards are used frequently through Europe, but have not yet been commonly adopted in the United States. While helpful, these devices and methods still fail to significantly shorten the time period a patient must wait before being treated at a care center. Specifically, EMR's only allow for the digitalization of medical records and do not significantly shorten current patient intake procedures.

Therefore, it is an object of the present invention to provide a method that enhances the speed and efficiency of patient intake. It is also an object of the present invention to provide a method of patient intake that could be used at any facility that provides patient care including but not limited to: doctors' offices, infirmaries, health centers, school nurses' offices, and the like.

### SUMMARY OF THE INVENTION

The present invention provides a method of patient intake that enables a patient who arrives at a treatment facility to receive medical treatment on an expedited basis by providing for the administration of certain standing orders to further diagnose and treat the patient before he is seen by a doctor. In general, the intake process is expedited by having the patient data entered by the patient, instead of by the providers; running certain intake processes in parallel instead of in series; and automating data exchange between multiple computer systems. The system accommodates patients with scheduled appointments as well as walk-ins.

### BRIEF DESCRIPTION OF THE DRAWINGS

FIG. 1 is a flowchart depicting the overall method according to the present invention.

FIG. 2 is a flowchart depicting the method of the present invention as applied to an example of needed care for an existing patient in a non-emergency situation.

FIG. 3 is a flowchart depicting the method of the present invention as applied to an example of needed care for a new patient in a non-emergency situation.

FIG. 4 is a flowchart depicting the method of the present invention as applied to an example of needed care for an existing patient in an emergency situation.

### DETAILED DESCRIPTION OF THE INVENTION

The present method is described herein and comprises having the patient enter patient data; verifying the patient's identity, symptoms, and insurance coverage; comparing the patient's symptoms to those in a database; and generating a set of standing orders to further diagnose and provide first aid to the patient before the patient sees a doctor or other health care provider.

The method is implemented in software on a computer in conjunction with one or more databases. One or more computers may be internal to a medical facility or networked across numerous facilities, as known in the art. Similarly, the software may be a single application or a compilation of several applications working together. In the preferred embodiment, a central database serves numerous treatment facilities that can enable a patient to be registered once and be considered an existing patient at any number of treatment facilities that are connected to that central database. Throughout the present method, any data that is gathered during the visit is automatically added to the patient's EMR; much of the data are entered by the patient himself or by the equipment used to run the tests used for diagnosis.

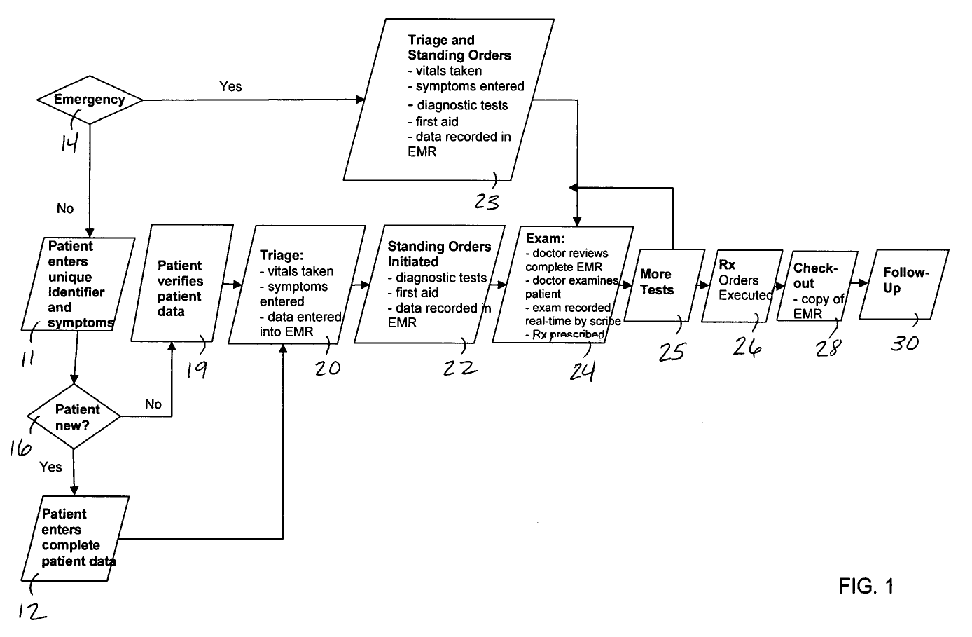

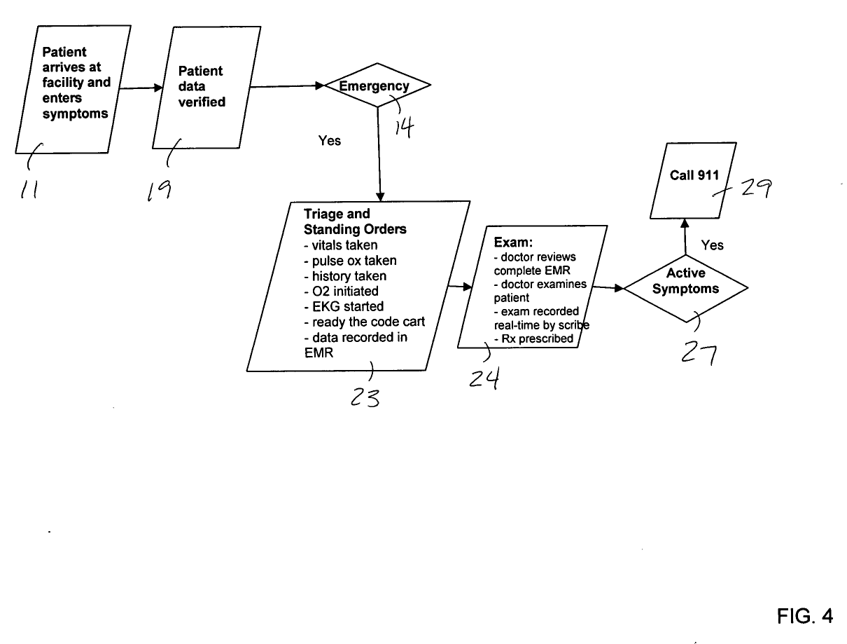

Turning to FIGS. 1 and 4, the method begins by determining whether the patient is in an emergency situation 14. This determination can be accomplished in several ways. For example, a patient can enter 11 his symptoms into a database. Entering 11 the patient's symptoms can be accomplished by numerous methods including one whereby the system queries the patient as to why he has visited the treatment facility, either by posing questions visibly on a computer screen or audibly. The patient can enter 11 his symptoms at the treatment facility or at home via the internet. As the patient enters 11 his symptoms into the database, the system compares the symptoms entered with a bank of symptoms pre-programmed into the database. Specifically, the computer determines if any of the symptoms entered by the patient correspond with those associated with medical emergencies that mandate immediate medical attention 14. The determination of the emergency status occurs almost immediately after the data are entered. One such method is the comparison of words entered into the system with a set of key words and phrases contained in the database that correspond with medical emergencies. For example, if the patient enters the words “chest pain” into the database, the computer determines that the patient is in an emergency situation as the term “chest pain” is associated with a possible heart attack. The database can contain any number of words or phrases that medical professionals deem necessary to enable the computer to properly recognize medical emergencies.

Alternatively, the patient may be presented a list of symptoms that he checks off, or a schematic illustration of the human anatomy on which the patient indicates the problem areas. The computer and associated database can also communicate with the patient in foreign languages if necessary. In lieu of the patient entering 11 his symptoms, the staff members present at the treatment facility can also recognize whether or not a patient is experiencing a medical emergency.

In a more autonomous embodiment, for example if the patient is at home viewing a website for a facility that implements this method, the patient self-determines whether he is in an emergency situation. The patient may read a list of symptoms provided by the website which indicates an emergency situation, such as chest pain, sudden paralysis on the right side of the body, or severe bleeding. If the patient has one or more of these symptoms, the patient will read instructions to call 911 immediately and forego the urgent care clinic. To confirm that a patient is not in an emergency situation, the website may further require the patient to execute a click-through agreement wherein the patient takes an affirmative action to indicate he is not in an emergency situation. For example, before being allowed to make an urgent care center appointment on the internet, the patient could be required to click on a button indicating that he has read through the symptoms and does not have any of them.

If the patient is not experiencing a medical emergency, the patent proceeds to enter 11 a unique identifier, such as his name, or social security number, or insurance number into the database. See FIGS. 1-3. At this point in the method, the patient is asked a series of questions about his particular symptoms. Questions relating to symptoms are designed to identify the needs of the patient and obtain at least a short medical history to lay the foundation for proper treatment. Examples of such questions are asking the patient if he is in pain, if he is suffering from nausea, if he has been injured, and if so, what part of his body is injured. In the preferred embodiment, the kiosks posing these questions are located in the lobby of the treatment facility and staff members are present to assist patients who need assistance. Kiosks for self-service patient data entry are known in the art, such as the MediKiosk™ kiosk, which is produced by Galvanon, Inc. While it is preferable that the staff are knowledgeable about this method and general medical needs, the staff need not be licensed physicians and nurses. Alternatively, the patient can enter 11 his unique identifier and symptoms online.

The system determines whether or not the patient is a new patient or an existing patient 16 by matching the unique identification data entered by the patient with known patient identification data contained within the database. For example, if the patient swipes an identification card that contains identification data for a patient that matches data stored within the database for existing patients, the patient is determined to be an existing patient. If the identification card contains data that does not match any of the data for known patients, or no card or other identification data are supplied by the patient, the patient is determined to be a new patient. Again, because this occurs electronically and automatically, a staff member is saved from doing the file search and retrieval. And, because it is electronic, it occurs instantly. Any type of software that is capable of functioning with this method and providing an EMR falls within the scope of the present invention. An example of such software for patient intake is Galvanon™ software. An example of software for generating EMRs is NextGen® EMR software produced by NextGen® Healthcare Information Systems, Inc.

A new patient proceeds to registration 12 wherein he provides patient data such as insurance coverage or other methods of payment. The patient's family medical history is obtained at registration 12 and an EMR is created. The patient data typically includes name, birth date, sex, insurance, medical history, and may include other data such as social and family history, employer, allergies, etc., as such data are known in the art for patient intake. The patient can enter this information into the database via any apparatus or medium, for example online through the internet, with a computer keyboard, a PC tablet, touch screen, or by swiping a smart card through a data reader. By self-entering the data into the database, the patient intake is more efficient because it prevents having a medical staff member from entering or re-entering the data which enables the staff to attend to patients instead of data. In the preferred embodiment, the patient's insurance information is automatically verified with the payor prior to treatment to determine the patient's eligibility, which services are covered, and the co-payment amount, if any. If the patient has insufficient insurance coverage, the patient will be advised that he will have to pay before leaving the facility. In this manner, the need to send invoices to patients is nearly eliminated because payment is made either at time of service or by the insurance payor.

While new patients arrive at triage after completing registration 12, existing patients (whose patient data is already on file) skip the majority of registration 12 and proceed to an abbreviated version of registration 12 referred to as verification 19. Existing patients verify 19 that information already contained within the database (such as the address and insurance information) is still accurate since their last visit. Following this confirmation at verification 19, existing patients proceed to triage 20. At triage 20, the patient's vital signs such as his heart rate, respiratory rate and blood pressure are recorded into the patient's EMR, either directly from the measurement equipment or manually by a staff member. Any additional symptoms that the patient might have that were previously not entered electronically are obtained at triage 20.

In conjunction with triage 20, the method provides for the automatic initiation of further diagnosis and the immediate care of the patient by the execution of standing orders 22 that correspond to the patient's condition and symptoms. The standing orders are preferably contained within the database, but may be known by the staff members. Standing orders 22, as referred to herein, are tests and protocols that the medical profession agrees are medically acceptable for known conditions. Examples of such standing orders include administering a urine test if patient complains or painful urination; taking a pulse oximetry reading if a patient is wheezing; taking an x-ray of a patient who complains of a swollen, hurting leg following a fall; administering acetaminophen or other fever reducer if the patient has a high temperature; or administering a cold compress to a burn. Other examples include first aid protocols, such as having the patient lie supine if dizzy or faint or administering O₂ if the pulse ox reading is low. The system is capable of directing the administration of the standing orders 22 based on the information provided by the patient. Finally, any standing orders 22 that are administered are recorded within the patient's EMR, along with the results.

Following registration 12 and the administration of triage 20 and standing orders 22, which may occur substantially simultaneously, the patient has his first encounter with a healthcare provider such as a doctor or nurse in an examination 24. The provider reviews the patient's EMR, current symptoms, results of the standing orders previously administered, and any other relevant information. The provider also interviews the patient and utilizes any additional information gained during the administration of the standing orders 22. The provider may request additional tests 25. If so, the examination continues after the test results are obtained. The exam is recorded by a staff member who functions as a scribe or the provider so that the results of the exam are entered into the patient's EMR. Finally, the provider prescribes any further treatments or medication. These prescriptions and treatments can include traditional drugs or other treatments such as exercise or other procedures.

In a preferred embodiment, the treatment facility includes an on-site pharmacy capable of filling any prescriptions written by the provider. The prescription is filled 26 by an on-site pharmacy and this information is added to the patient's EMR.

The patient checks out 28 of the treatment facility after receiving his prescription (if any). Any follow-up instructions, post-visit care, and subsequent visits for the treatment facility are explained to the patient and the patient is provided with a paper or electronic copy of his EMR, which includes any x-rays or other results that were taken during his visit in the preferred embodiment.

Finally, in the preferred embodiment, the method concludes with a follow-up procedure 30. The follow-up procedure 30 may include a letter and phone call confirming the patient's visit to the treatment facility and inviting the patient to return for future treatment. It may also include scheduling follow-up appointments, test results, or inquiries about the patient's recovery. The follow-ups may be provided by an automated system, such as Medvoice®, which relays test results, referral authorizations, prescription renewals, follow-up instructions general information, and preventative healthcare messages. In addition to the phone system described above, follow-up can include access to a secure website to retrieve lab results or information about specific conditions or treatments. In the preferred embodiment, a thank-you letter is also sent to the patient as a part of follow-up 30.

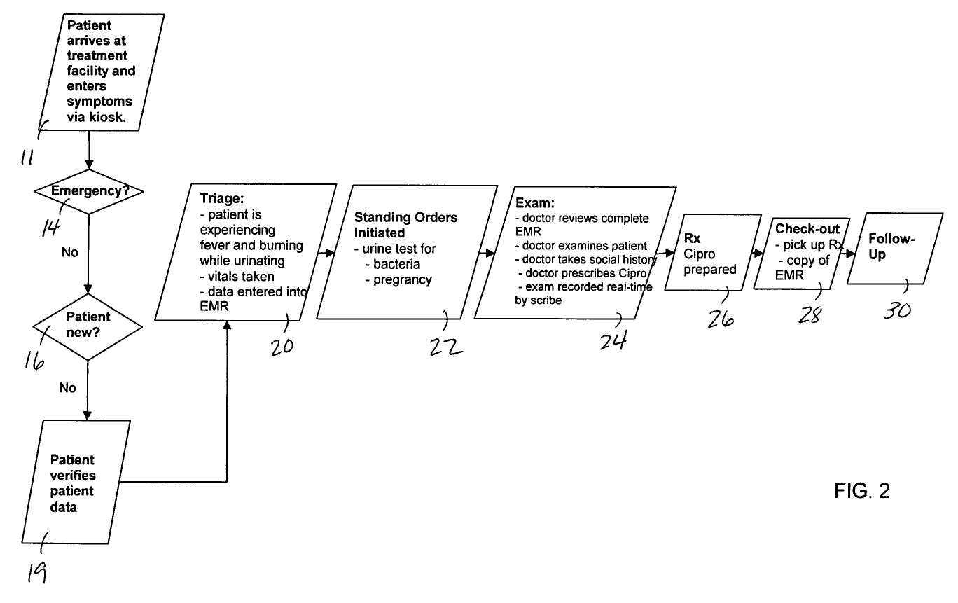

Turning to FIGS. 2-4, three brief examples will be described to better illustrate how the method operates in practice.

### EXAMPLE 1

A 25 year old female comes to an urgent care center complaining of a fever and pain while urinating. See FIG. 2. First, she enters 11 these symptoms into a computer database by using a kiosk in the lobby of a treatment facility with at screen and keyboard. The screen displays a query which asks the patient to more fully describe the symptoms. The patient enters “pain while urinating” and “fever” via the touch screen in response.

In the preferred embodiment, the system poses additional queries to the patient to more precisely identify from the patient's problem. For example, the system might ask if the patient if she has seen blood in her urine, had a hysterectomy, or the date of the patient's last menstrual period.

The computer analyzes the symptoms entered to determine whether or not she is experiencing a medical emergency. The computer determines whether “painful urination” is a medical emergency 14. When the computer fails to match the symptoms entered by the patient with any of symptoms in the database associated with medical emergencies, the computer concludes that the patient is not in an emergency situation.

The patient swipes her identification card through a data reader in the kiosk to enter 11 her patient data. The computer recognizes the patient because she has previously visited the facility and has an EMR in the database. The EMR is automatically retrieved and displayed on a touch screen in the kiosk. Because the patient's identity contained on her identification card matched an identity of an existing patient contained within the database, the computer determines 16 that the patient is an existing patient and the patient proceeds to confirm her identification data and health insurance information at verification 19. The patent then proceeds to triage 20 and is able to skip registration 12.

The patient is escorted to triage unit 20 by a staff member. Once in triage, the staff member takes the patient's vital signs, including blood pressure, pulse, respiratory rate, and temperature, which confirms that the patient actually has a fever. The data is entered into the system by the staff member or downloaded directly from the measurement devices, if they are electronically connected to the system.

Standing order(s) 22 are determined from and given in response to the patient data and vital signs. The database is searched and provides two standing orders in response to this situation: 1) get a urine test for bacteria and pregnancy and 2) administer acetaminophen for fever and pain. The staff member gives the patient the needed urine test, which reveals that the patient has a bacterial infection and is not pregnant, and administers acetaminophen. The test results are added to the patient's EMR.

Then the patient is examined 24 by a doctor. The doctor reviews the EMR, including the test results and vitals and determines that the patient is suffering from a urinary tract infection. The doctor asks several questions to establish the social history of the patient to see if the cause of the infection can be determined. The doctor prescribes the antibiotic ciprofloxacin and recommends over-the-counter pain relievers. The ciprofloxacin prescription is filled by the in-house pharmacy 26 and the patient picks up her prescription and copy of her EMR before she leaves 28 the treatment facility. Throughout her entire stay at the urgent care center, her EMR has been updated with her symptoms, diagnosis, and treatment she received while at the center, and her prescription. Her final contact 30 with the urgent care center related to the urinary tract infection occurs when she receives a phone call from the urgent care center thanking her for her visit and reminding her to finish her antibiotics, even if the pain has subsided.

### EXAMPLE 2

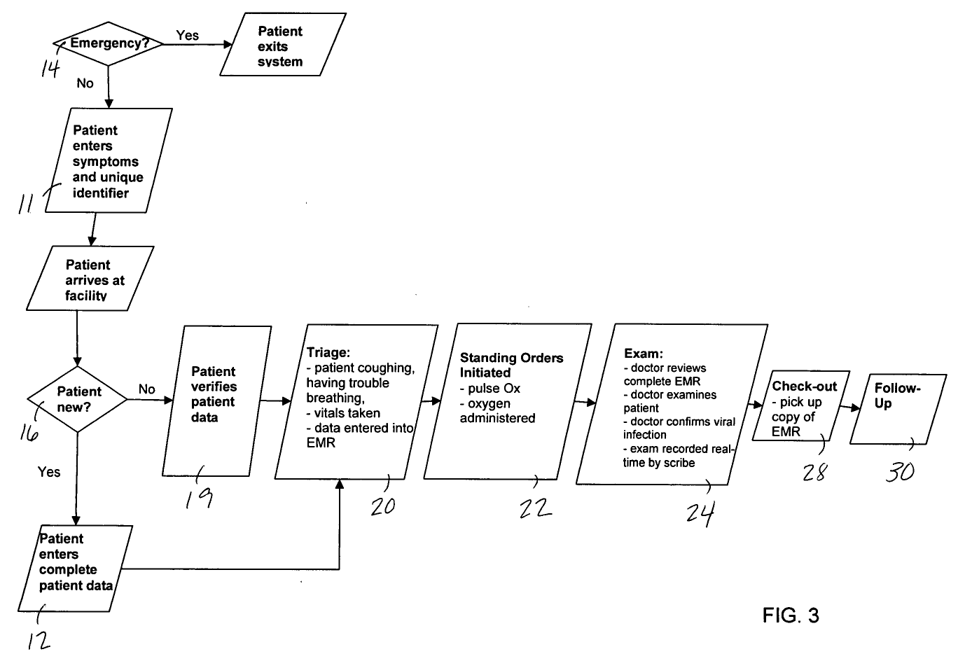

A male patient suffers from pain and swelling in his leg. This patient has never been to an urgent care center. See FIG. 3. The patient searches the internet for an urgent care center that is near his house and finds a local facility and visits the facility's website. The first page on the website is a warning page which displays certain symptoms of emergencies such as chest pain and numbness in the limbs to determine if the patient is experiencing a medical emergency 14. If the patient has any of these symptoms, he is advised to call 911 and not continue with the process. In the preferred embodiment, this web page is similar to a “click wrap” agreement and the patient clicks an icon or button indicating that he is not suffering from any of these symptoms before he is permitted to view any additional web pages and enter his information online.

Since leg pain and swelling are not symptoms indicative of an emergency, the patient clicks on the button confirming that he is not suffering form a medical emergency and proceeds to other web pages where he enters 11 his information. This information includes his name, symptoms, and insurance information. He then obtains an appointment time for that day, and prints out the address to the facility. He arrives at the treatment facility and is greeted by a staff member who verifies that the new patient data entered online is correct. From the data that has been entered, it is confirmed that the patient's leg pain is a non-emergency situation 14. Further, the system determines 16 that this patient is not an existing patient because no identification data was entered that matches the record of an existing patient and the system begins to compile an EMR for this patient. The staff member directs the new patient to enter additional information needed for registration 12.

The patient proceeds to triage 20. At triage, a staff member confirms that the patient's leg is in pain. A set of standing orders is administered 22 including to x-ray the leg, keep the leg in a straight and extended position, and to apply a cold compress to the swollen area. The patient proceeds to see the doctor for the exam 24, where the doctor confirms that the leg is broken and sets the leg in a cast. The doctor also prescribes pain relievers 26 which the patient receives before he leaves the treatment facility. The patient checks out and receives a copy of his newly-created EMR in both paper and electronic form 28. A few days later at home, the patient receives 30 a follow up letter thanking him for his visit and requesting that he call the treatment center to set up an appointment to have his injury checked and his condition assessed.

### EXAMPLE 3

An 89 year old man with chronic heart disease and chest pain arrives at an urgent care center and moves to a kiosk to start his process. The patient enters a list of symptoms provided at the kiosk which indicates an emergency situation. See FIG. 4. The staff starts triage and standing orders immediately 23. The patient's vital signs are taken, O₂ is initiated, EKG started, the code cart is readied in the event of cardiac arrest, and a cardiac history of the patient is taken, including whether the patient has taken nitroglycerin or aspirin prior to arrival. In this situation, the patient is an existing patient and has a smart card that contains his personal information. To assist in identifying the patient, a staff member takes the smart card from the patient and swipes it through the kiosk as he is being taken to triage. The system confirms that the patient is an existing patient because of the identification data contained on his identification card that was swiped at the kiosk and insurance is verified 19.

In conjunction with the administration of standing orders, the patient is immediately examined by a provider 24 who evaluates the patient's condition and determines whether active heart attack symptoms are present 27. In this example, it is determined that the patient is suffering from a heart attack and 911 is called immediately 29 for transport of the patient to a hospital emergency room. If active symptoms had not presented, the patient could be treated at the treatment facility as noted above.

As described above, the method is highly advantageous as it provides prompt registration and pre-examination care prior to the patient seeing a doctor. Further, it eliminates duplicate data entry and allows several patient intake steps to proceed substantially simultaneously. Although the examples above are very specific, the method contemplates that patients with different ailments can be treated by the method described. It should also be understood that while a specific order of events has been described, modifications to this order can be made without departing from the scope of the present invention. For example, in an alternative embodiment, a patient's symptoms could be relayed to a doctor in real time as the standing orders were being administered to diagnose and treat the patient 22. Additionally, the order of determining whether or not the patient is experiencing a medical emergency and obtaining his symptoms can be adjusted for different embodiments such as using the internet to find a treatment facility as described in example two or physically coming to a treatment facility for treatment as described in the other examples.

Additionally, it should be noted that while this specification mentions the use of the method in urgent care centers, the method can be utilized in any location where patients are being treated by a doctor. Examples of such venues include health centers on college campuses, doctors' offices, school nurses' offices, infirmaries, hospitals, and any other place where patients could benefit from receiving immediate attention and treatment before seeing a doctor.

Finally, while there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. A method of providing medical treatment to a patient comprising:
a) entering patient data into an electronic medical record, whereby the patient enters substantially all of the patient data including symptoms;
b) determining one or more standing orders appropriate for the patient from a database of standing orders, the determined standing order based on the patient's symptoms; and
c) triaging the patient at substantially the same time as initiating one or more of the determined standing orders, where triaging and initiating occurs before the patient is examined by a licensed healthcare provider; and
d) automatically exchanging patient data between multiple software applications.

2. A method of providing medical treatment to a patient comprising:
a) entering patient data into an electronic medical record, whereby the patient enters substantially all of the patient data including symptoms;
b) determining one or more standing orders appropriate for the patient from a database of standing orders, the determined standing order based on the patient's symptoms; and
c) initiating one or more of the determined standing orders before the patient is examined by a licensed healthcare provider and recording the results of the standing order into the electronic medical record.

3. A method of providing medical treatment to a patient according to claim 2 further comprising:
a) examining the patient and simultaneously recording the examination into the electronic medical record; and
b) providing treatment to the patient.

4. The method according to claim 2 further comprising providing the patient with a copy of the electronic medical record.

5. The method according to claim 2 further comprising contacting the patient and inviting them to return for follow-up treatment.

6. The method according to claim 2 further comprising determining whether the patient is suffering from a medical emergency and providing emergency treatment to the patient if necessary.

7. The method according to claim 2 wherein electronic medical record is pre-existing and specific to the patient.

8. The method according to claim 7 wherein the patient accesses the electronic medical record by passing a data-carrying device through a piece of computer hardware.

9. The method according to claim 8 wherein the data carrying-device is a smart card.

10. The method according to claim 2 wherein the standing orders are known, medically acceptable procedures that aid in further diagnosing the patient.

11. The method according to claim 2 wherein the standing orders are known, medically acceptable procedures for treating the patient.

12. The method according to claim 2 wherein all the events take place at a single treatment facility.

13. The method according to claim 12 further comprising prescribing and delivering prescription treatment to the patient before the patient leaves the treatment facility.

14. The method according to claim 12 further comprising an additional treatment facility that is connected to the first treatment facility by a computer network.

15. A method of providing medical treatment to a patient comprising:
a) entering patient data into an electronic medical record, whereby the patient enters substantially all of the patient data including symptoms;
b) receiving the patient at a treatment facility;
c) determining one or more standing orders appropriate for the patient from a database of standing orders, the determined standing order based on the patient's symptoms;
d) initiating one or more of the determined standing orders before the patient is examined and recording the results of the standing order into the electronic medical record;
e) providing treatment to the patient;
f) discharging the patient from the treatment facility; and
g) contacting the patient with follow-up information.

16. The method according to claim 15 wherein the standing orders are known procedures to further diagnose the patient.

17. The method according to claim 15 wherein the step of entering the patient data into the electronic medical record occurs at a kiosk at the treatment facility.

18. The method according to claim 15 wherein the step of entering the patient data occurs before the patient arrives at the treatment facility.

19. The method according to claim 18 wherein the data is entered via the internet.

20. A method of providing medical treatment to a patient comprising:
a) entering patient data into an electronic medical record, whereby the patient enters substantially all of the patient data including symptoms;
b) determining whether the patient has an urgent medical need;
c) receiving the patient at a treatment facility;
d) determining one or more standing orders appropriate for the patient from a database of standing orders, the determined standing order based on the patient's symptoms;
e) initiating one or more of the determined standing orders before the patient is examined and recording the results of the standing order into the electronic medical record;
c) examining the patient including review of the electronic medical record and simultaneously recording the examination into the electronic medical record;
d) providing treatment to the patient, whereby the treatment includes a drug prescription;
e) supplying the patient with the drug prescription at the treatment facility;
f) providing the patient a copy of the electronic medical record;
g) discharging the patient from the treatment facility; and
h) contacting the patient with follow-up information.

21. The method according to claim 19 further comprising, if the patient's medical need is non-urgent:
a. identifying the patient's symptoms and recording the symptoms into the electronic medical record; and
b. taking the patient's vital signs and recording the vital signs into the electronic medical record.
